(19) United States
(12) Patent Application Publication
(10) Pub. No.: US 2013/0007784 A1
(43) Pub. Date: Jan. 3, 2013

(54) METHOD FOR CONTROLLING AN AUDIENCE MEASUREMENT RELATING TO BROADCAST DATA, CORRESPONDING CONTROLLER, DEVICE AND SYSTEM

(75) Inventor: Anne-marie Praden, Ventabren (FR)

(73) Assignee: Gemal To SA, Meudon (FR)

(21) Appl. No.: 13/508,021

(22) PCT Filed: Nov. 4, 2010
(86) PCT No.: PCT/EP2010/066844

§ 371 Date: Sep. 17, 2012

(30) Foreign Application Priority Data
Nov. 5, 2009 (EP) 09306060.6

(51) Int. Cl. H04H 60/33

(52) U.S. Cl. 725/9

(57) ABSTRACT

The invention relates to a method for controlling an audience measurement relating to broadcast data. According to the invention, the method comprises the following steps: an information sending step in which a server sends to at least one device at least one piece of information for disallowing an execution of an audience measurement relating to at least one piece of identified content data that is broadcast or to be broadcast; and an audience measurement stopping step in which the device stops an audience measurement relating to the identified content data. The invention also relates to corresponding server, device and system for controlling an audience measurement relating to broadcast data.

### FIELD OF THE INVENTION

The invention relates, in a general manner, to a method for controlling an audience measurement relating to broadcast data.

Within the present description, an audience measurement is a process of measuring usage statistics in relation with a consumption of content data.

Moreover, the invention relates to a controller of an audience measurement relating to broadcast data.

Furthermore, the invention relates to a device for controlling an audience measurement relating to broadcast data. The device may be in particular a terminal or a token.

Within the present description, a token is any smart object that is intended to communicate with the outside world. The token may cooperate with a terminal, as a host device, that receives the broadcast data.

Finally, the invention relates to a system for controlling an audience measurement relating to broadcast data.

The present invention is notably applicable within a mobile TV (acronym for television) field.

### STATE OF THE ART

As known per se, notably within a standard termed OMA BCAST (acronym for “Open Mobile Alliance-BroadCAST”), a broadcasting server broadcasts notably content data that is intended to a fleet of terminals.

A European Patent Application with number 09305014.4 describes a solution based upon a broadcasting of an audience measurement request within the broadcast content data. Each concerned terminal, as audience measuring device, sends back, through a return channel, to an audience collecting device, an audience measure relating to the broadcast content data, as response to the received audience measurement request.

However, the content data may relate to a political programme, a religious programme, or other type of data. An audience measure relating to such content data gives information on the person's belief(ves). Thus, such an audience measure relating to the broadcast content data consumed by a terminal user may reveal a personal opinion of the terminal user. The audience measure may therefore contain sensitive personal data relating to the terminal user. For example, a law that may be local to the terminal location, may classify data as being personal when the data reveals racial and/or ethnic origin, political opinion, religious and/or philosophical belief(ves), trade-union membership, and/or when the data regards health and/or sex life. The law may stipulate that an audience measurement relating to such personal data is either prohibited or authorized.

Thus, there is a need to control an audience measure for one particular content data consumed by a terminal user.

### SUMMARY OF THE INVENTION

The invention proposes a solution for satisfying the just hereinabove specified need by providing a method for controlling an audience measurement relating to broadcast data. The broadcast data is to be received by at least one terminal.

According to the invention, the method comprises the steps that follow. A controller sends to at least one terminal at least one piece of information for forbidding or authorizing to send an audience measure relating to at least one piece of identified content data that is broadcast or to be broadcast. At least one terminal receives the at least one piece of information for forbidding or authorizing to send an audience measure relating to at least one piece of identified content data that is broadcast or to be broadcast. And the terminal inhibits or authorizes respectively to send an audience measure relating to the identified broadcast content data.

The principle of the invention consists in that a controller, as principal, transmits to one terminal(s) data for preventing or permitting to issue a measure of an audience of one content(s) contained and identified within the broadcast data stream (or the data stream to be broadcast) and the terminal(s) execute(s) by, respectively, not sending or sending a corresponding audience measure.

It is to be noted that the corresponding broadcast content data stream(s) is (are) followed or consumed by the concerned terminal user(s).

Within the present description, an audience measure is a result of an audience measurement implemented at the terminal side.

Since each of the terminals receives and processes the broadcast content data to let the terminal user benefit from the broadcast content data (or consume it), the concerned terminal(s) also receive(s) an interdiction or permission for issuing an audience measure. Each of the concerned terminals is then involved to forbid or authorize to issue an audience measure. To authorize or forbid to issue an audience measure, this is the terminal that interprets the received information for authorizing or forbidding to issue an audience measure under the control of the controller.

It is to be noted that the concerned terminal user(s) is (are) the consumer(s) of the content data that is broadcast. Each consumer or following person may benefit from the broadcast content data, through at least one of the user senses, such as the eyesight, the hearing, the touch, the smell and/or the taste, and/or through a terminal data processing, like a data downloading, a data storing and/or an execution of a particular application (or service). When the terminal implements an audience measurement on a specific content, the terminal tracks and reports the consumption, as audience measure, by the terminal user of the said specific content, while using at least one of the above listed user's senses.

A receipt of the audience measure permission by the concerned terminal(s) allows the terminal to send an audience measure relating to the concerned particular content data stream.

On the contrary, a receipt of the audience measure interdiction prevents the terminal from sending any audience measure relating to the concerned particular content data stream. Accordingly, no audience measure is provided by the terminal, avoiding then the unveiling of sensitive data relating to the terminal user, like some user's belief(ves). Since no audience measure is sent, no sensitive data relating to the terminal user is revealed.

The invention solution makes it possible, thanks to a static piece of information received at the terminal side, to disallow or allow to transmit an audience measure for at least one particular content that is broadcast to a fleet of terminal(s).

Advantageously, the terminal inhibits or authorizes to send an audience measure relating to the identified broadcast content data either, when a measurement of the audience relating to the identified content data has not been performed, by, respectively, inhibiting or authorizing to launch an execution of a measurement of the audience relating to the identified broadcast content data, or, when a measurement of the audience relating to the identified content data has been performed, by, respectively, inhibiting or authorizing to launch an execution of a sending of a measure of the audience relating to the identified broadcast content data.

According to a further aspect, the invention is a controller of an audience measurement relating to broadcast data.

According to the invention, the controller is adapted to send at least one piece of information for forbidding or authorizing to send an audience measure relating to at least one piece of identified content data that is broadcast or to be broadcast.

The controller may be a server.

According to still a further aspect, the invention is a device for controlling an audience measurement relating to broadcast data.

According to the invention, the device is adapted to receive at least one piece of information for forbidding or authorizing to send an audience measure relating to at least one piece of identified content data that is broadcast or to be broadcast, and to respectively inhibit or authorize to send an audience measure relating to the identified broadcast content data.

The device may be a terminal or a token.

As terminal, it can be any device including means for processing data and comprising or being connected to means for receiving data from outside, comprising or being connected to means for presenting data to a user, such as a loudspeaker, a display screen, an odor diffuser, and/or a mechanical vibrator. For example, the terminal may be a mobile telephone, a Personal Digital Assistant (or PDA), a Personal Computer (or PC), a mobile laptop, or a portable TeleVision (or TV), a set top box, a netbook.

As token, it can be any electronic device comprising data processing means, at least one memory (or being connected to one memory), and an Input/Output (or I/O) communication interface. The token can constitute any electronic medium, as a Secure Removable Module (or SRM). For example, it can be embodied within a smart card, a smart dongle of the USB (acronym for “Universal Serial Bus”) type, a Secure Digital card (or SD card), a Multi-Media Card (or MMC) or a chip to be fixed to a terminal, as a host device, preferably in a removable manner. The token is any electronic medium that may have different form factors.

According to a further aspect, the invention is a system for controlling an audience measurement relating to broadcast data. The system comprises at least one terminal receiving the broadcast data.

According to the invention, the system further comprises a controller. The controller is adapted to send to at least one terminal at least one piece of information for forbidding or authorizing to send an audience measure relating to at least one piece of identified content data that is broadcast or to be broadcast. And at least one terminal is adapted to receive the at least one piece of information for forbidding or authorizing to send an audience measure relating to at least one piece of identified content data that is broadcast or to be broadcast, and inhibit or authorize to send an audience measure relating to the identified broadcast content data respectively.

### BRIEF DESCRIPTION OF THE DRAWINGS

Additional features and advantages of the invention will be more clearly understandable after reading a detailed description of one preferred embodiment of the invention, given as an indicative and non-limitative example, in conjunction with the following drawings:

FIG. 1 illustrates a simplified diagram of one embodiment of a system comprising a broadcasting server, as controller, a mobile telephone, as terminal, and a smart card, as token, the system being adapted to prohibit or authorize the token to send an audience measure relating to content data that is broadcast or to be broadcast from the broadcasting server to the terminal, according to the invention; and

FIG. 2 represents a simplified flow chart of one embodiment of the method implemented by the different entities of the system of FIG. 1 that allows the token to block or let execute a transmission of an audience measure thanks to a predetermined value of a piece of information transported by a broadcast data stream.

### DETAILED DESCRIPTION

A description of the invention that follows is made with a reference to the name of the entities or the messages defined by the OMA BCAST standard or by a mobile radio-communication network standard, such as a GSM (acronym for “Global System for Mobile communications”), UMTS (acronym for “Universal Mobile Telecommunication System”) and/or CDMA (acronym for “Code Division Multiple Access”) network(s).

Nevertheless, the present invention can be applied to any broadcasting network having technical background similar to the broadcasting network defined in OMA BCAST standard and to any radio-communication network having technical background similar to the GSM, UMTS and/or CDMA network(s).

As broadcasting network(s), it can be, for example, a Digital Video Broadcasting-Handheld (or DVB-H) network; a Digital Video Broadcasting-Satellite Handheld (or DVB-SH) network; a Digital Video Broadcasting-Satellite (or DVB-S) network; a Digital Video Broadcasting-Territorial (or DVB-T) network; a Digital Audio Broadcasting (or DAB) network; a Digital Multimedia Broadcasting (or DMB) network; a Terrestrial-Digital Multimedia Broadcasting (or T-DMB) network; a Digital Radio Mondiale (or DRM) network; a Multimedia Broadcast Multicast Services (or MBMS) network; a BroadCast MultiCast Services (or BCMCS) network; a Forward Link-Only (or FLO) network; a WiMAX network; an Integrated Mobile Broadcast (or IMB) network; an Integrated Services Digital Broadcasting-Terrestrial (or ISDB-T) network; an Advanced Television Systems Committee Mobile Digital TV (or ATSC Mobile DTV) network; a third generation network; and/or a fourth generation network, such as Long Term Evolution (or LTE) network.

Herein under is considered a case in which the invention method for controlling an audience measurement relating to broadcast data is implemented by a broadcasting server relating to a broadcasting network, as controller and sender of one piece(s) of information for forbidding or authorizing an audience measure, a mobile telephone, as terminal, and a smart card, as token cooperating with the terminal and as device for controlling an audience measurement relating to broadcast data and receiver of the said piece(s) of information, so as to forbid or authorize the token to send a measure of an audience relating to an identified broadcast content data.

However, the invention method for controlling an audience measurement relating to broadcast data may be implemented by a dedicated server for managing an audience measurement, as controller, instead of a broadcasting server. According to such an embodiment (not represented), the dedicated server is aware of any content data stream that may be or not the subject of an audience measurement. Moreover, the dedicated server may be a peer to peer server that identifies each terminal to be concerned by an inhibition or authorisation for issuing a measure of an audience relating to an identified broadcast content data.

Likewise, the invention method for controlling an audience measurement relating to broadcast data may be implemented by a terminal, instead of a token, as device for controlling an audience measurement relating to broadcast data at the receipt of the piece(s) of information for forbidding or authorizing to send an audience measure. In other words, according to such an embodiment (not represented), the terminal does not cooperate with a token, so as to forbid or authorize the terminal to send a measure of an audience relating to an identified broadcast content data. According to such an embodiment, the terminal is adapted so as to exert the functions carried out by the token that is hereinafter described.

As token, the smart card may be a Universal Integrated Circuit Card (or UICC), as a Subscriber Identity Module (or SIM) type smart card, that cooperates with the mobile telephone, as terminal. The smart card securely stores an International Mobile Subscriber Identity (or IMSI), as a unique number associated with all GSM and UMTS network mobile phone users. The IMSI is used to identify a subscriber in relation to at least one mobile radio-communication network.

The SIM type smart card can be, for example, a SIM smart card for a GSM network, a Universal Subscriber Identity Module (or USIM) for a UMTS network, a Removable User Identity Module (or RUIM), a CDMA Subscriber Identity module (or CSIM) for a CDMA network, and/or an Internet Protocol multimedia Services Identity Module (or ISIM) for IP Multimedia Subsystem (or IMS). Naturally, the just aforementioned list is not exhaustive but only for exemplifying purposes and is not considered to reduce the scope of the present invention.

As to the terminal, instead of being constituted by a mobile telephone, it may be, for example, a PC, a desktop computer, a laptop computer, a set top box, a netbook and/or a PDA.

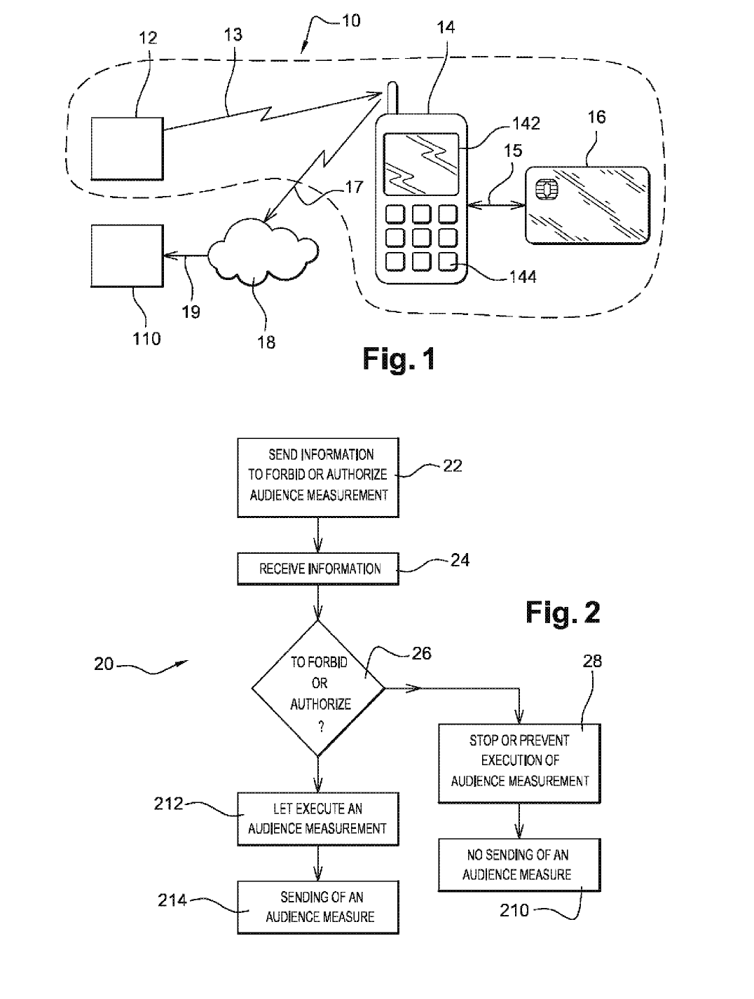

FIG. 1 shows one embodiment of an electronic system 10 for controlling an audience measurement relating to broadcast data.

The system 10 for controlling an audience measurement relating to broadcast data comprises a broadcasting server 12, as controller, a mobile telephone 14, as terminal, and a SIM type smart card 16, as token and device for controlling an audience measurement relating to data broadcast from the broadcasting server 12.

For the sake of clarity and conciseness, the broadcasting server 12, the mobile telephone 14 and the SIM type smart card 16 are termed hereinafter the server 12, the phone 14 and the card 16 respectively.

The server 12 transmits, through a broadcasting channel 13, in particular content data to the phone 14 among a plurality of terminals (not represented) without identifying any addressee (among the terminals) of the content data.

According to the present described invention embodiment, the server 12 inserts, within the data to be broadcast, one piece(s) of information for forbidding or authorizing each terminal to send a measure of an audience relating to an identified content data that is broadcast or to be broadcast.

For the sake of clarity and conciseness, the piece(s) of information for forbidding or authorizing to send a measure of an audience relating to an identified content data that is broadcast or to be broadcast may be respectively termed hereinafter the prohibition or the authorization.

The broadcasting channel is a one-way communication channel, namely a downlink channel, namely from the server 12 to the phone 14. The broadcasting channel is transported through the broadcasting network.

In another embodiment (not represented), the server 12 and the phone 14 are linked through a two-way communication channel, namely a downlink and an uplink. The downlink, i.e. from the server 12 to the phone 14, is used to transfer the prohibition or the authorization. The uplink, i.e. from the phone 14 to the server 12, is used to transfer, for example, an acknowledgment of an audience measure prohibition or authorization and/or an audience measure, when applicable.

For the sake of clarity, only one single phone 14 is represented. However, several phones, as terminals, receive the broadcast data and their respective users may consume at least one content data stream comprised within the broadcast data.

The behaviour of the phone 14 and the card 16 is one and the same for each phone and its associated card that are involved within the invention.

The system 10 allows, thanks to the prohibition or the authorization, to prevent or not prevent from using an audience measure relating to content data that is broadcast and consumed by a phone user.

The system 10 constitutes a simple and cheap architecture that is simple and cheap to implement.

If the audience measurement is thus prevented, then an audience metering process at the phone side is stopped. Thus, no audience measure is sent from or through the phone 14 (when an audience metering device is the phone 14 or the card 16 respectively). No privacy information specific to the phone user is therefore revealed through an audience measure relating to the consumed content data.

To prevent from using an audience measure relating to a content data, the system 10 either stops an already launched execution of a measurement of an audience relating to the concerned content data at the phone side or does not allow to launch an execution of an audience measurement relating to the concerned content data at the phone side and/or blocks a sending of an audience measure relating to the concerned content data at the phone side. No audience measure relating to the concerned content data is therefore sent from or through the phone 14. Thus, the phone user consumes the concerned broadcast content data without being the subject of an audience measure.

It is to be noted that, when the audience measure relating to the concerned content data has nevertheless been generated at the phone side and not sent, the audience measure is preferably erased from a memory of a metering device that generates the audience measure, namely the phone 14 or the card 16.

The server 12 includes at least one microprocessor, as data processing means, at least one memory and at least one Input/Output (I/O) interface, as means for communicating with outside (not represented).

The memory of the server 12 may store data to be broadcast including the content data.

The server 12 has at least one I/O Interface connected with at least one content data providing entity, such as one server, so as to receive from the content data providing entity at least one content data stream to be broadcast.

The memory of the server 12 stores notably one application for sending to at least one phone 14 one piece(s) of information for forbidding or authorizing it (them) to send a measure of an audience relating to content data that may be consumed by a phone user and is identified within the broadcast data stream.

The server microprocessor executes the application for sending the piece(s) of information for forbidding or authorizing to send a measure of an audience relating to the concerned content data stored within the server memory.

The controller is the entity that sends to (one) phone(s) data for forbidding or authorizing the execution, at the terminal side, of at least one of the following processing:
an audience measurement, and
a sending of an audience measure.

In case where the audience measurement has been performed at the phone side (i.e. either the phone 14 or preferably the card 16), the measure of an audience relating to the concerned content data is either not sent or sent, according to the nature of the data for forbidding or authorizing, to a collecting server 110, as collecting device.

The server 12 transmits an audience measurement prohibition or authorization with only one unique message included within the broadcast data, to a fleet of terminals, either directly or through a broadcasting device when the controller is separate and distinct from the broadcasting device.

Such a transmission of one unique message allows to save bandwidth relating to the involved broadcasting network. No dedicated message is thus individually addressed to each of the fleet of terminals, among which the phone 14, like within a peer to peer network.

The server 12, as controller, is the master of the audience measurement controlling process while, at the phone side, and more exactly, for the preferred embodiment, at the card side, as controlled device, is the slave of the audience measurement controlling process.

The server 12 has at least another I/O interface connected with at least one external entity, like a server, to receive the signalling that a measure of an audience relating to a specific content is either prohibited or authorized. The external entity(ies) may be operated by a company dealing with audience measurement or on its behalf. Thus, some law relating to an interdiction for receiving an audience measure relating to some particular content data and that is sensitive for the end user can be enforced.

Likewise, the server 12 has also at least one I/O interface connected with the broadcasting network, so as to deliver, through this latter, to terminals (among which the phone 14), on the one hand, at least one content data stream, and, on the other hand, at least one piece(s) of information for forbidding or authorizing to send a measure of an audience relating to at least one identified content data stream that has already been delivered or is to be delivered.

When the audience measure relating to the concerned content data is to be inhibited, the interdiction is received by the phone 14 and prevents the phone 14 from sending a corresponding audience measure.

On the contrary, when the audience measure relating to the concerned content data is to be authorized, the piece(s) of information for authorizing to send a corresponding audience measure is received by the phone 14 and allows the phone 14 to send, through a telecommunication network 18, a corresponding audience measure to the collecting server 110.

The phone 14 includes at least one microprocessor, as data processing means, at least one memory and at least one I/O interface, as means for communicating with outside (not represented).

The phone microprocessor processes and controls data within the phone 14 and/or data to be exchanged with outside of the phone 14. The phone microprocessor controls and communicates with all the components of the phone 14, such as the I/O interfaces.

The phone 14 is preferentially an intermediary communication entity from the server 12 to the card 16. The phone 14, as intermediary communication entity, receives from the server 12 and transmits to the card 16 the prohibition or the authorization.

The phone 14 processes the concerned content data and provides its user with the concerned content data.

The phone 14 translates or renders consumable, possibly thanks to data, like data relating to one key(s) originating from the card 16, the content data, to provide a service to its user, as end user. As provided service, for example, the phone 14 is able to make the content data (received from the server 12) perceptible to a phone user, notably through at least one phone interface with a user, like a phone loudspeaker and/or a phone display, for audio and/or video data. The phone 14 allows the phone user, as consumer, to consume the content data that is broadcast from the server 12.

The memories store data notably relating to an Operating System and one application(s) supported by the phone 14.

The I/O interfaces may comprise a contact interface (not represented) of the type ISO (acronym for <<International Standard Organization>>) 7816, as one I/O interface, to interact, through a bi-directional link 15, with the card 16.

The I/O interfaces comprise an antenna for receiving data broadcast, via a long range radiofrequency link 13, through the broadcasting network, with the server 12.

The I/O interfaces comprise an antenna for communicating, via a long range radiofrequency link 17, through a telecommunication network 18, with the collecting server 110.

The phone user selects or chooses a broadcast service, channel and/or program within the broadcast content data stream(s) by possibly using the keyboard 144, the display screen 142, and/or any other man machine interface.

Preferably, the phone 14 includes, as one I/O interface, a display screen 142, so as to display a selection menu allowing the phone user to select, among the broadcast data streams, at least one broadcast content data stream that she/he desires to consume.

The display screen 142 may display video content data that is broadcast from the server 12, so that the phone user consumes video content data stream(s).

The phone 14 may be connected to an external display screen that may allow the phone user to benefit from the concerned video content data.

The phone 14 preferentially comprises, as one I/O interface, a keyboard 144, so that the phone user selects one broadcast content data stream(s).

According to another embodiment (not represented), instead of equipping the phone 14, a keyboard is connected to the phone 14.

According to another embodiment (not represented), the phone 14, as terminal, is connected to a selecting device, like a mouse for moving a pointer on a display screen, a remote control, and/or a pen for selecting a broadcast content data stream on a tactile display screen.

The phone 14 preferentially comprises, as one I/O interface, a loudspeaker (not represented), so that the phone user benefits from broadcast audio content data stream(s).

According to another embodiment (not represented), the phone 14, as terminal, is connected to an external loudspeaker that may allow the phone user to benefit from the concerned audio content data.

The phone user may use a service guide that is broadcast to select the broadcast service, as the concerned content data. The concerned content data is thus identified within the broadcast data stream.

The concerned content data may be any kind of data stream relating to a broadcast service, such as a TV program. A consumption of the broadcast service by the phone user(s) may reveal personal data that is too sensitive and/or may be protected by one particular law that may be specific to a zone where the phone 14 receives the broadcast service.

The concerned content data, once selected by the phone user, is presented to her/him, i.e. felt by her/him, notably seen and/or heard by her/him.

As to the identified broadcast content data, it can constitute data relating to at least one application, audio and/or video data provided by the server 12. The application data that can be considered may be related to any application that provides, when executed by the phone 14 and/or the card 16, a service to the phone user, such as a game.

Preferably, the card 16 is the device for controlling an audience measurement relating to broadcast data that is under the control of the server 12, so as to forbid or authorize the card 16 to send, through the phone 14, a measure of an audience relating to at least one identified content data that is broadcast from the server 12.

The system 10 for controlling an audience measurement relating to broadcast data allows to:
either stop/prevent from sending an audience measure relating to an identified content(s) to the collecting server 110, or
let execute, on one hand, an audience measurement relating to an identified content(s) that is (are) broadcast, and, on the other hand, a sending of the audience measure resulting from the audience measurement.

The card 16 is coupled to the phone 14.

The card 16 is connected, through a bi-directional link 15, to the phone 14. The bi-directional link 15 may be constituted by one physical contact and/or one contact-less link.

To communicate, the phone 14 and the card 16 may use, through the bi-directional link 15, Application Protocol Data Unit (or APDU), Universal Serial Bus (or USB) protocol, HyperText Transfer Protocol (or HTTP), and/or any other data transfer protocol(s).

The card 16 receives from the server 12, preferably through the phone 14, the piece(s) of information for forbidding or authorizing the card 16 to send a measure of an audience relating to content data.

The card 16 includes a chip.

The chip of the card 16 includes at least one microprocessor, as data processing means, volatile and non-volatile memories, at least one I/O interface linked together through a data and control bus (not represented).

The card microprocessor processes and controls data within the chip and/or data to be exchanged with outside of the chip. The card microprocessor controls and communicates with all the components of the chip, such as the I/O interface(s).

The card memories store data notably relating to an Operating System and one application(s) supported by the card chip.

The card memories may be constituted by one or several EEPROM (acronym for “Electrically Erasable Programmable Read-Only Memory”), one or several ROM (acronym for “Read Only Memory”), one or several Flash memories, and/or any other memories of different types, like one or several RAM (acronym for “Random Access Memory”).

The card 16 is preferably an audience measuring (also termed metering) device that implements completely the audience measurement itself. In other words, when a piece(s) of information sent by the server 12 is to authorize the card 16 to send an audience measure relating to at least one piece of identified content data that is broadcast or to be broadcast, the card 16 generates an audience measure.

The card 16 is preferably a reporting device that sends, through the phone 14, the generated audience measure, as report, to the collecting server 110.

According to another embodiment, the phone 14 is the reporting device.

The card memories store at least one application for measuring an audience relating to a broadcast content data stream and sending a corresponding audience measure.

The card memories also store at least one application for retrieving, reading and interpreting the piece(s) of information for forbidding or authorizing the card 16 to send a measure of an audience relating to content data that is broadcast and identified within the broadcast data.

The card memories may store at least one application providing at least one security function, a digital signature, a card identification, a card authentication, an on-board key generation, and/or a secure exchange for on-line transactions.

The card memories may also store credential(s), such as an encryption key, so as to protect the data that is thus exchanged with the external entity. The credential(s) can be used to authenticate the server 12 before any external entity, like the card 16, and/or sign data to be sent to outside world, like the collecting server 110, possibly by using data that is received from outside.

The card I/O interface(s) comprise(s) a contact interface (not represented) of the type ISO 7816, as one I/O interface, to interact with the phone 14. The contact interface is intended to let communicate, through the bi-directional link 15, the card 16 with the phone 14.

The card 16 is involved, as one possible entity, as metering and reporting device, included within the system 10 for controlling an audience measurement relating to broadcast data.

The card 16 is able to send back, through the phone 14 and the telecommunication network 18, via an Over-The-Air (or OTA) channel, to the collecting server 110, an audience measure, as an audience report, relating to the content data, when applicable.

When the piece(s) of information indicates that the card 16 is allowed to send an audience measure relating to the identified broadcast content data, the card microprocessor executes, in a complete manner, the application for measuring an audience relating to a selected broadcast content data stream and sending a corresponding audience measure. The card microprocessor also executes the application for retrieving, reading and interpreting the piece(s) of information for forbidding or authorizing the card 16 to send a measure of an audience relating to content data.

Otherwise, i.e. when the piece(s) of information indicates that the card 16 is disallowed to send an audience measure relating to the identified broadcast content data, the card microprocessor does not execute or executes, only partially, the application for measuring an audience relating to a selected broadcast content data stream and sending a corresponding audience measure. The card microprocessor also executes the application for retrieving, reading and interpreting the piece(s) of information for forbidding or authorizing the card 16 to send a measure of an audience relating to content data. Thus, the card 16 does not report any measure of an audience relating to the identified broadcast content data to the collecting server 110.

The collecting server 110 is connected to the telecommunication network 18, through a link 19 that is at least mono-directional, namely directed from the telecommunication network 19 to the collecting device 110.

The collecting server 110 may be connected to the terminals through one or several mobile radio-telecommunication network(s), a network of the Internet type and/or other different telecommunication network(s).

The collecting server 110 plays a role of a receiver of all the audience measures originating from terminals, among which there is the phone 14, when the audience measure regarding at least one content data stream is authorized at the terminal side.

The server 12 and the collecting server 110 are distinct from each other and constitute therefore two separates servers.

According to another embodiment, the server 12 and the collecting server 110 are included within one and the same device.

FIG. 2 depicts one example of a sequence 20 of steps that is implemented by the server 12, the phone 14 and the card 16, so as to control an audience measurement.

It is assumed that the card 16 is the entity that is controlled through the prohibition or the authorization emanating from the server 12.

It is to be noted that the prohibition or the authorization is static information. In other words, this (these) piece(s) of information does (do) not constitute a command by itself.

The prohibition or the authorisation that is addressed to the card 16 is (are) transmitted:
either before a broadcasting of the concerned content data,
or during the broadcasting of the concerned content data,
(or just after the broadcasting of the concerned content data but before a sending of an audience measure from the card 16)

Firstly, a message that transports the prohibition or the authorization is either broadcast to a fleet of terminals or sent 22 to one or several identified terminals (including the phone 14) by the server 12, as controller.

The content data to be broadcast by the server 12 may be previously encrypted, so as to protect access to the content data. The decryption key that is used to decrypt the encrypted content data is conveyed by a message termed Short Term Key Message (or STKM) by the OMA BCAST standard.

For example, the prohibition or the authorization may be conveyed by at least one of the following messages:
a content decryption key message, as a message that conveys the decryption key used to decrypt the encrypted content data, like STKM;
a discovery service, as a means for discovering the different content data that is broadcast, like a Service Guide (or SG) defined by the OMA BCAST standard and/or
another specific message that is timely linked to the content data stream.

As known per se, the STKM is regularly broadcast from the server 12. The STKM is addressed to the card 16, which extracts the content encryption keys (if the user has the rights to consume the content data) and sends back these keys to the terminal to allow it the decryption of the encrypted content data.

According to a preferred embodiment, when the identified content data is encrypted before being broadcast, the prohibition or the authorization is included within the STKM, as a message comprising a key used to decrypt the identified broadcast encrypted content data. Thus, in the same time, the phone 14 sends to the card 16 a current STKM and the prohibition or the authorization.

As known per se, the SG is included within the broadcast data stream and comprises the content fragment that includes data describing the content data that is broadcast. The content fragment data may be displayed to the end user, after a dedicated formatting for its display. The SG also includes an access fragment used by the terminal to retrieve, among the broadcast data, the data of the channel selected by the phone user and, possibly, the corresponding key stream (when the broadcast content data is encrypted). For example, the terminal retrieves, within the access fragment, the multicast address of the channel selected by the phone user, and the multicast address of the corresponding key stream.

According to another embodiment (not represented), a content fragment of the SG includes the piece(s) of information for forbidding or authorizing the phone 14 to send a measure of an audience relating to the concerned content data. In other words, the phone 14 parses the discovery service available through the broadcast data (or SG), retrieves, for example, within the content description part of the SG, the piece(s) of information for forbidding or authorizing the phone 14 to send an audience measure relating to the concerned content data. The phone 14 is adapted to extract, read and interpret the piece(s) of information for forbidding or authorizing the phone 14 to send a measure of an audience relating to the concerned content data. The phone 14 turns off or on the audience measurement process for the concerned content data depending on the nature of the piece(s) of information for forbidding or authorizing to send a measure of an audience relating to the concerned content data.

According to still another embodiment (not represented), the prohibition or the authorization is comprised within a dedicated broadcast message that is timely linked to the broadcast content data. In other words, the prohibition or the authorization is broadcast while the content data has just been broadcast or is itself (currently) being broadcast or is to be shortly broadcast. According to such an embodiment, the phone 14 selects the multicast address of a channel chosen by the phone user, may also select the multicast address of a stream for sending a key used to decrypt an encrypted content data, and uses the SG access fragment, to retrieve a multicast address that is used to deliver the dedicated broadcast message. The phone 14 is adapted to extract, read and interpret the piece(s) of information for forbidding or authorizing the phone 14 to send a measure of an audience relating to the concerned content data. The phone 14 turns off or on the audience measurement process for the concerned content data depending on the nature of the piece(s) of information for forbidding or authorizing to send a measure of an audience relating to the concerned content data.

To avoid an alteration or modification of a nature of the piece(s) of information for forbidding or authorizing to send a measure of an audience relating to the concerned content data for instance by the phone user, this (these) piece(s) of information is (are) protected as to its integrity. For example, this (these) piece(s) of information and possibly the message that transports this (these) piece(s) of information is (are) protected by using, for example a check sum or a Message Authentication Code (or MAC) algorithm.

To be authenticated by the card 16 as the sender of the prohibition or the authorization, the server 12 can sign the prohibition or the authorization by using, for example, a Hash Message Authentication Code (or HMAC) type algorithm using a server representative key.

To be authenticated as the sender of the prohibition or the authorization, the server 12 can encrypt the prohibition or the authorization by using a private key algorithm, such as, for example, a Data Encryption Standard (or DES), 3 DES, or Advanced Encryption Standard (or AES). In such a case, the server 12 has to communicate to the card 16 a secret key. To establish a secret key session, the server 12 and the card 16 may use a mechanism of mutual authentication of the Authentication and Key Agreement (or AKA) type or the Public Key Infrastructure (or PKI) type.

To protect from outside an access to the nature of the piece(s) of information for forbidding or authorizing to send a measure of an audience relating to the concerned content data this (these) piece(s) of information is (are) protected as to its access. For example, this (these) piece(s) of information and possibly the message that transports this (these) piece(s) of information is (are) encrypted at the server side, and the card 16 stores a decryption key and a decryption algorithm to be used, so as to decrypt this (these) encrypted piece(s) of information.

When the phone 14 receives the STKM including the prohibition or the authorization, the phone 14 relays the STKM to the card 16.

The card 16 receives 24 the STKM and parses it.

The card 16 is adapted to extract from the STKM, read and interpret the piece(s) of information for forbidding or authorizing to send a measure of an audience relating to the concerned content data, as prohibition or authorization.

The card 16 determines 26 whether the piece(s) of information for forbidding or authorizing to send a measure of an audience relating to the concerned content data indicates to either disallow an execution of the audience measurement process or allow a complete execution of the audience measurement process.

The server 12 and the card 16 both know what the piece(s) of information for forbidding or authorizing to send a measure of an audience relating to the concerned content data have to be, in order to inhibit or let execute a transmission of a measure of an audience relating to the concerned content data.

The piece(s) of information for forbidding or authorizing the card 16 to send a measure of an audience relating to content data may be indicated through one or several bits. According to one particular embodiment, a value of one bit, as flag, announces whether the card 16 is to be inhibited or authorized to send an audience measure relating to the concerned content data. For example, the value “zero” of the concerned bit is set when the card 16 has to inhibit to send an audience measure relating to the identified broadcast content data. The value “one” of the concerned bit is set when the card 16 has to authorize to send an audience measure relating to the identified broadcast content data.

According to another embodiment (not represented), the server 12 broadcasts two bits, one bit dedicated to indicating that the card 16 is to be inhibited to send a measure of an audience relating to the concerned content data while another bit is dedicated to signalling that the card 16 is to be authorised to send a measure of an audience relating to the concerned content data.

For example, the value of the flag, namely “one” or “zero”, indicates to either execute or not execute completely the audience measurement process at the phone side respectively.

The card 16 therefore interprets the piece(s) of information for forbidding or authorizing to send a measure of an audience relating to the concerned content data.

When the piece(s) of information for forbidding or authorizing to send a measure of an audience relating to the concerned content data indicates to prohibit an issue of a measure of a corresponding audience, i.e. the flag value is “zero”, the card 16 preferably stops or prevents 28 from an execution of the audience measurement process.

The card 16 turns off the audience measurement process for the concerned content data. More exactly, if the card microprocessor has began an execution of the audience measurement process, then the card microprocessor stops the execution. Otherwise, i.e. if no execution of the audience measurement process has been launched, the card microprocessor prevents from launching an execution of the audience measurement process.

According to another embodiment (not represented), the step 28 for stopping or preventing from an execution of the audience measurement process is not carried out. In other words, the card 16 generates internally a measure of an audience relating to the concerned content data. The card 16 erases preferably the generated audience measure stored within the card memory.

Then, the card 16 does not issue 210 any measure of audience relating to the concerned content data.

On the contrary, when the piece(s) of information for forbidding or authorizing to send a measure of an audience relating to the concerned content data indicates to authorize an issue of a measure of a corresponding audience, i.e. the flag value is “one”, the card 16 lets 212 execute the audience measurement process.

The card 16 turns on the audience measurement process for the concerned content data. More exactly, if the card microprocessor has began an execution of the audience measurement process, then the card microprocessor goes on with the execution. Otherwise, i.e. if no execution of the audience measurement process has been launched, the card microprocessor launches an execution of the audience measurement process.

Consequently, the card 16 does transmit 214, through the phone 14, to the collecting server 110 a measure of an audience relating to the concerned content data.

1. A method for controlling an audience measurement relating to broadcast data,
wherein the method comprises the following steps:
an information sending step in which a server sends to at least one device at least one piece of information for disallowing an execution of an audience measurement relating to at least one piece of identified content data that is broadcast or to be broadcast; and
an audience measurement stopping step in which the device stops an audience measurement relating to the identified content data.

2. Method according to claim 1, wherein the device is either a terminal or a smart card.

3. Method according to claim 1, wherein the at least one piece of information for disallowing an execution of an audience measurement is included within at least one service guide.

4. Method according to claim 1, wherein the at least one piece of information for disallowing an execution of audience measurement is included within a specific message that is timely linked to the identified content data.

5. Method according to claim 1, wherein the at least one piece of information for disallowing an execution of an audience measurement is included within a Short Term Key Message.

6. Method according to claim 1, wherein a first value of one piece of information is predetermined to disallow an execution of an audience measurement relating to the identified content data, when a value of the piece of information matches the predetermined first value, the device does not execute an audience measurement relating to the identified content data.

7. Method according to claim 1, wherein the server inserts within data to be broadcast the at least one piece of information for disallowing an execution of an audience measurement.

8. A server for controlling an audience measurement relating to broadcast data,
wherein the server is configured to send at least one piece of information for disallowing an execution of an audience measurement relating to at least one piece of identified content data that is broadcast or to be broadcast.

9. A device for controlling an audience measurement relating to broadcast data,
wherein the device is configured to:
receive at least one piece of information for disallowing an execution of an audience measurement relating to at least one piece of identified content data that is broadcast or to be broadcast, and
stop an audience measurement relating to the identified content data.

10. A system for controlling an audience measurement relating to broadcast data,
wherein the system comprises a server,
the server being configured to send to at least one device at least one piece of information for disallowing an execution of an audience measurement relating to at least one piece of identified content data that is broadcast or to be broadcast; and in that the system comprises at least one device, the device being configured to
stop an audience measurement relating to the identified content data.
